(19) United States
(12) Patent Application Publication
(10) Pub. No.: US 2015/0082054 A1
(43) Pub. Date: Mar. 19, 2015

(54) System and Method for Establishing a Secure Digital Environment

(71) Applicant: Venux LLC, Brooklyn, NY (US)

(72) Inventors: Eugene Nosko, Brooklyn, NY (US); Yevgeniy Rasporsky, Brooklyn, NY (US); Vlad Kruglyansky, Marlboro, NJ (US)

(73) Assignee: Venux LLC, Brooklyn, NY (US)

(21) Appl. No.: 14/250,441

(22) Filed: Apr. 11, 2014

Related U.S. Application Data
(60) Provisional application No. 61/868,201, filed on Aug. 21, 2013.

(51) Int. Cl. H04L 29/06; H04L 9/32

(52) U.S. Cl. CPC H04L 63/045; H04L 9/3242; H04L 63/083
USPC 713/193

(57) ABSTRACT

Systems and methods for providing secure data using a two-layered security mechanism. The systems and methods generate key data based on received input and generate a hash for a given key. The generated hash is utilized as an asymmetric or symmetric encryption key for encrypting data and is simultaneously used as an identifier for subsequent identification and retrieval.

### CROSS-REFERENCE TO RELATED APPLICATIONS

This application claims priority to U.S. Provisional Patent Application Ser. No. 61/868,201, filed Aug. 21, 2013, the entire disclosure of which is hereby expressly incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present disclosure relates generally to computer security. More particularly, the present disclosure relates to systems and methods for establishing a secure digital environment in which data can be generated, modified, and stored using various computer security techniques.

2. Description of Related Art

Cryptography is a method of protecting the data (of any sort/type) in order to preserve secrecy. Modern cryptography is heavily based on mathematical theory and computer science practice. Cryptographic algorithms are designed around computational hardness assumptions, making such algorithms hard to break in practice by any adversary. It is theoretically possible to break such a system, but it is infeasible to do so by any known practical means. These schemes are therefore termed “computationally secure.” Theoretical advances, e.g., improvements in integer factorization algorithms, and faster computing technology require these solutions to be continually adapted.

There are two types of cryptographic algorithms in existence: symmetric and asymmetric encryption. Symmetric encryption is the oldest and best-known technique. A secret key, which can be a number, a word, or simply a string of random letters, is applied to the text of a message to change the content in a particular way. This might be as simple as shifting each letter by a number of places in the alphabet. As long as both sender and recipient know the secret key, they can encrypt and decrypt all messages that use this key. The problem with secret keys is exchanging them over the Internet or a large network while preventing them from falling into the wrong hands. Anyone who knows the secret key can decrypt the message.

One answer is asymmetric encryption, in which there are two related keys—a key pair. A public key is made freely available to anyone who might want to send a message to an authorized person. A second, private key is kept secret that is only known by the authorized person. Any message (text, binary files, or documents) that is encrypted by using the public key can only be decrypted by applying the same algorithm, but by using the matching private key. Any message that is encrypted by using the private key can only be decrypted by using the matching public key. This means that one does not have to worry about passing public keys over the Internet (the keys are inherently public). A problem with asymmetric encryption, however, is that it is slower than symmetric encryption. It requires far more processing power to both encrypt and decrypt the content of the message.

In computer science, a “hash function” is any algorithm that maps data of variable length to data of a fixed length. A “one-way” hash function is a function that is easy to compute on every input, but difficult to invert provided the appearance of random input. It is to be understood that terms “easy” and “hard” are used in the sense of computational complexity theory, specifically the theory of polynomial time problems. The ideal cryptographic hash function has four main properties:

1. It is easy to compute the hash value for any given message

2. It is infeasible to generate a message that has a given hash

3. It is infeasible to modify a message without changing the hash

4. It is infeasible to find two different messages with the same hash.

In real world environments, hash functions are mostly used for data integrity checks and passwords hashing. The values returned by these types of hash function are called hash values, hash codes, hash sums, checksums or simply hashes. Hash functions are primarily used to generate fixed-length output data that acts as a shortened reference to the original data. This is useful when the output data is too cumbersome to use in its entirety.

One practical use is a data structure called a hash table where the data is stored associatively. Searching for a person's name in a list is slow, but the hashed value can be used to store a reference to the original data and retrieve constant time (barring collisions).

Both, cryptographic algorithm as well as one-way hash function requires the key to process the data. In practice, the key can be any user input, such as password or combination of username plus the password. Any scheme of key construction can be applied yet it is recommended to use proven techniques.

### SUMMARY OF THE INVENTION

The present disclosure describes a dual-layered security system, method, and computer readable medium for overcoming the limitations of existing security methods.

Specifically, one embodiment of the system described herein comprises an input/output device and a storage device operative to store encryption key data and encrypted information. In one embodiment, the encryption key data is generated based on input data. In some embodiments, the encryption key data is generated based on input data wherein the input data comprises a username and password.

The system further comprises a hashing module operative to generate a hashed key based on the key data using a hashing algorithm. In one embodiment, the hashing module selects a hashing algorithm based on the key data.

The system further comprises an encryption module operative to encrypt input data using an encryption algorithm and the hashed key and generate encrypted data. In one embodiment, the encryption module and decryption module choose an encryption/decryption algorithm based on the key data. In alternative embodiments, the encryption module further stores the encrypted data within the storage device wherein the encryption module stores the encrypted data using a filename based on the hashed key data.

The system further comprises a decryption module operative to decrypt the encrypted data using a decryption algorithm and a key received from the input/output device, wherein the decryption hashes the received key and decrypts the encrypted data using the hashed, received key. In some embodiments the encryption algorithm comprises an asymmetric algorithm or a symmetric algorithm.

The disclosure further describes a method for securing data. The method comprises receiving key data and generating a hashed key based on the key data using a hashing algorithm. The method then encrypts the input data using an encryption algorithm and the hashed key to generate encrypted data and decrypts the encrypted data using a decryption algorithm a key received from the input/output device, wherein the decrypting comprises hashing the received key and decrypting the encrypted data using the hashed, received key.

In one embodiment, the received key data is generated based on input data which may comprise a username and password. In one embodiment, the method further comprises selecting a hashing algorithm based on the key data. Alternatively, or in conjunction with the foregoing, the method may further comprise choosing an encryption/decryption algorithm based on the key data. In one embodiment, the method comprises storing the encrypted data, wherein storing the encrypted data comprises storing the encrypted data using a filename based on the hashed key data. In some embodiments the encryption algorithm comprises an asymmetric algorithm or a symmetric algorithm.

Furthermore, the present disclosure is directed towards a non-transitory computer readable media comprising program code that when executed by a programmable processor causes execution of a method for securing data. The computer readable media comprises computer program code for receiving key data, wherein the received key data is generated based on input data.

The computer readable media further comprises computer program code for generating a hashed key based on the key data using a hashing algorithm. The computer readable media further comprises computer program code for encrypting input data using an encryption algorithm and the hashed key to generate encrypted data. The computer readable media further comprises computer program code for storing the encrypted data, wherein storing the encrypted data comprises storing the encrypted data using a filename based on the hashed key data. The computer readable media further comprises computer program code for decrypting the encrypted data using a decryption algorithm a key received from the input/output device, wherein the decrypting comprises hashing the received key and decrypting the encrypted data using the hashed, received key.

In one embodiment, the computer readable media further comprises computer program code for selecting a hashing algorithm based on the key data and choosing an encryption/decryption algorithm based on the key data

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a system for securing data transmission between computing devices according to one embodiment of the disclosure;

FIG. 2 illustrates a device for securing data transmissions to and from a computing device according to one embodiment of the disclosure;

FIG. 3 illustrates a method for securing data according to one embodiment of the disclosure;

FIGS. 4A and 4B illustrate a method for encrypting and decrypting data according to one embodiment of the disclosure.

### DETAILED DESCRIPTION OF THE INVENTION

In the following description of the embodiments of the disclosure, reference is made to the accompanying drawings that form a part hereof, and in which is shown by way of illustration exemplary embodiments in which the invention may be practiced. It is to be understood that other embodiments may be utilized and structural changes may be made without departing from the scope of the disclosed invention.

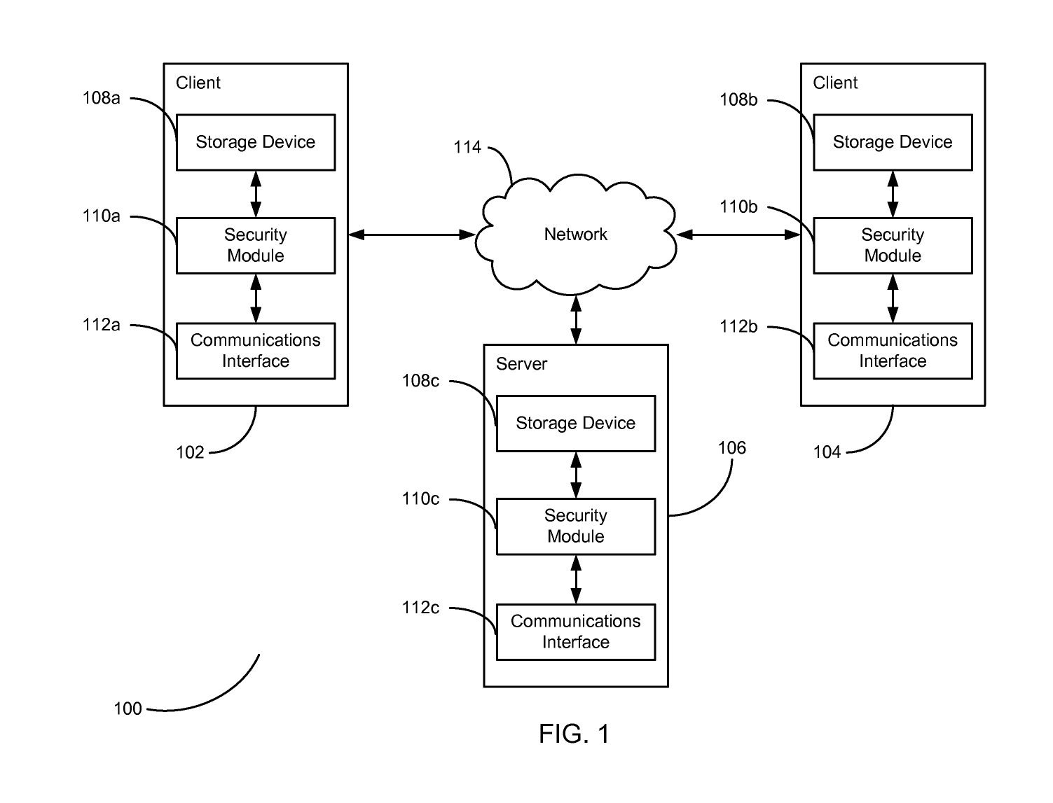

FIG. 1 illustrates a system 100 for securing data transmission between computing devices according to one embodiment of the disclosure. Specifically, FIG. 1 illustrates client devices 102, 104 and server device 106 communicatively coupled to a network 114, such as the Internet. Although only three devices 102, 104, 106 are illustrated, the following discussion applies equally to network containing various combinations of client and server devices not necessarily illustrated in FIG. 1.

Client and server devices 102, 104, 106 are configured to transmit data amongst each other as needed. That is, client 102 may transmit data to client 104 and server 106; client 104 may transmit data to client 102 and server 106; and server 106 may transmit data to clients 102, 104. Furthermore, any device 102, 104, 106 may transmit data to any other device connected to the network 114. In the illustrated embodiment, the devices 102, 104, and 106 may utilize known protocols to transmit data such as HTTP, TCP, IP, UDP, or other similar protocols utilized over computer networks. In further embodiments, the devices 102, 104, and 106 may utilize additional protocols such as TLS, SSL, SPDY, or other similar protocols.

Each device 102, 104, and 106 contains a storage device 108a-c, security module 110a-c, and communications interface 112a-c that enables the devices 102, 104, and 106 to communicate data securely. Although not illustrated, the devices 102, 104, and 106 may contain additional hardware and/or software to perform other perfunctory or auxiliary tasks.

The storage devices 108a-c store data associated with the devices 102, 104, and 106. For example, storage devices 108a-c may comprise non-volatile storage such as hard drive or solid state drive storage with an associated file system. Alternatively, storage devices 108a-c may comprise volatile storage such as random access memory (RAM) or similar storage devices. Notably, storage device 108a-c may indeed comprise any device capable of storage data for retrieval and storage by the security modules 110a-c and are not limited to a particular storage technology. The storage devices 108a-c stores both encrypted and unencrypted data. In one embodiment, the storage devices 108a-c may store both types of data without regard to the encrypted nature of the data. In alternative embodiments, the storage devices 108a-c may differentiate between the types of data.

Devices 102, 104, and 106 further contain security modules 110a-c, respectively, that are communicatively coupled to storage devices 108a-c. As illustrated in FIG. 1, security module 110a-c may read and write data to storage devices 108a-c. For example, a security module 110a may read unencrypted data from storage device 108a, encrypt the data, and transmit the data using the communications interface 112a. Alternatively, the security module 110a may receive encrypted data from communications interface 112a, decrypt the data and store the data in the storage device 108a. In another example, security module 110a may act as a broker and control access to encrypted and/or unencrypted data stored in storage device 108a by verifying credential information received via communications interface 112a.

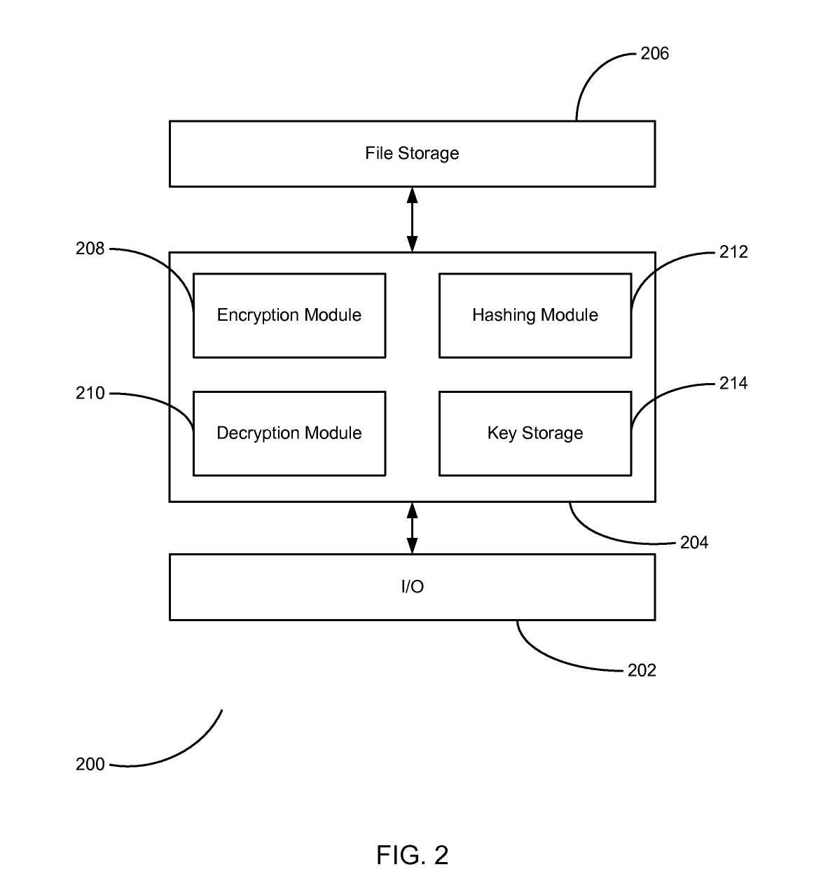

FIG. 2 illustrates a device for securing data transmissions to and from a computing device according to one embodiment of the disclosure. As illustrated in FIG. 2, a device 200 contains an input/output module 202, a security device 204, and a file storage device 206. The illustrated security device 204 may comprise an encryption module 208, a decryption module 210, a hashing module 212, and key storage 214. In the illustrated embodiment, the components 202-214 may be implemented in hardware, software, or a combination of both software and hardware depending on the configuration of the system 200. Specifically, security module 204 may comprise either software or dedicated hardware, or a combination of the two, in order to execute the processes described herein.

In the illustrated embodiment, key storage 214 may store key-related data such as public and private keys. Public and/or private keys may be utilized for symmetric cryptographic algorithms including, but not limited to the algorithms listed in Table 1

TABLE 1

AES
Blowfish
DES
Triple DES
Serpent
Twofish
Camellia
CAST-128
IDEA
RC2
RC5
SEED
Skipjack
TEA
XTEA
3-Way
Akelarre
Anubis
ARIA
BaseKing
BassOmatic
BATON
BEAR and LION
CAST-256
CIKS-1
CIPHERUNICORN-A
CIPHERUNICORN-E
CLEFIA
CMEA
Cobra
COCONUT98
Crab
Cryptomeria/C2
CRYPTON
CS-Cipher
DEAL
DES-X
DFC
E2
FEAL
FEA-M
FROG
G-DES
GOST
Grand Cru
Hasty Pudding cipher
Hierocrypt
ICE
IDEA NXT
Intel Cascade Cipher
Iraqi
KASUMI
KeeLoq
KHAZAD
Khufu and Khafre
KN-Cipher
Ladder-DES
Libelle
LOKI97
LOKI89/91
Lucifer
M6
M8
MacGuffin
Madryga
MAGENTA
MARS
Mercy
MESH
MISTY1
MMB
MULTI2
MultiSwap
New Data Seal
NewDES
Nimbus
NOEKEON
NUSH
PRESENT
Q
RC6
REDOC
Red Pike
S-1
SAFER
SAVILLE
SC2000
SHACAL
SHARK
SMS4
Spectr-H64
Square
SXAL/MBAL
Threefish
Treyfer
UES
Xenon
xmx
XXTEA
Zodiac

Alternatively, or in conjunction with the symmetric algorithm(s), the system 200 may utilize asymmetric cryptographic algorithms including, but not limited to the algorithms listed in Table 2.

TABLE 2

Benaloh
Blum-Goldwasser
Cayley-Purser
CEILIDH
Cramer-Shoup
Damgård-Jurik
DH
DSA
EPOC
ECDH
ECDSA
EKE
ElGamal (signature scheme)
GMR
Goldwasser-Micali
HFE
IES
Lamport
McEliece
Merkle-Hellman
MQV
Naccache-Stern
NTRUEncrypt
NTRUSign
Paillier
Rabin
RSA
Okamoto-Uchiyama
Schnorr
Schmidt-Samoa
SPEKE
SRP
STS
Three-pass protocol
XTR

The system 200 further comprises a hashing module 212. In the illustrated embodiment, the hashing module 212 is operative to receive input data, such as a key from key storage 214, and generate a hash value using a known hashing algorithm including, but not limited to the algorithms listed in Table 3.

TABLE 3

Adler32 (not strong)
CRC32 (not strong)
SHA-0
SHA-1
SHA-2
SHA-256
SHA-384
SHA-512
HAVAL
MD2
MD4
MD5
SHA1
Tiger
TTH
BTIH
EDonkey 2000
AICH
WHIRLPOOL
GOST
HAS-160
RIPEMD-160
RIPEMD-320
EDON-R
Snefru

Thus the hashing module 212 and key storage 214 may, together, provide at least two data values for the encryption and decryption modules 208, 210, namely a key and a hashed key.

Encryption module 208 and decryption 210 modules are operative to receive the key and hashed key from the hashing module 212 and key storage 214 and encrypt and decrypt data stored within file storage 206 or received via input/output module 202.

In one embodiment, the encryption module 208 may read data from file storage 206 and encrypt the data using a key retrieved from key storage 214 using a known encryption algorithm. The encryption module 208 may then write the encrypted data to file storage 206 and identify the encrypted data using a filename equal to the hashed key value received from hashing module 212.

Subsequent requests for the encrypted data may be processed by the decryption module 210, for example, requests from a remote user received via the input/output module 202. In one embodiment, the decryption module 210 receives a key from input/output module 202 and translates the key using the hash function utilized by the hashing module 212. The module 210 may then access a file from file storage 206 using the generated hash file, if such a file exists. Secondly, the decryption module 210 may then decrypt the previously encrypted data file using the key received via input/output module 202 to provide decrypted data via input/output module 202.

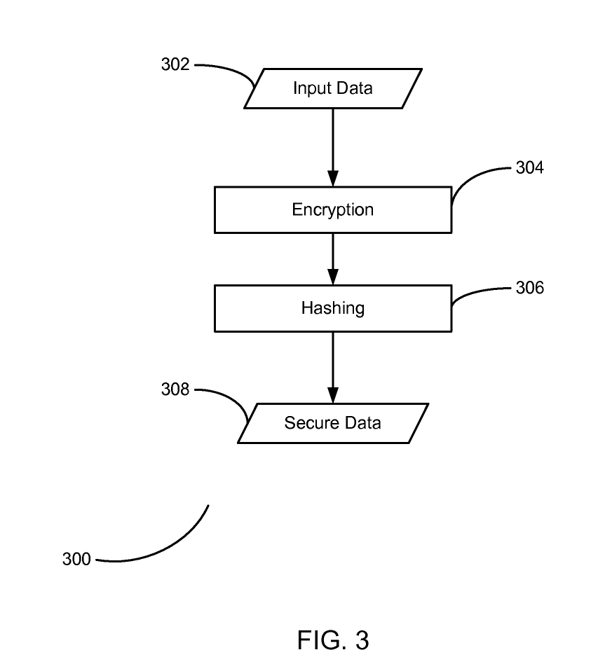

FIG. 3 illustrates a method for securing data according to one embodiment of the disclosure. As illustrated in FIG. 3, input data 302 is transformed in to secure data 308 using dual-layer method of security, namely, encryption 304 and hashing 306. The first layer comprises multiple cryptographic operations, step 304. In the illustrated embodiment, the method 300 utilizes either a symmetric encryption algorithm or an asymmetric encryption algorithm as discussed previously. In the illustrated embodiment, the method 300 encrypts the input data 302 using the chosen encryption algorithm and a well-defined key, such as a username and password combination. For example, in a simplistic scenario a username (“Patent”) and password (“Examiner”) may be combined to form the key “PatentExaminer” used by the chosen encryption algorithm. If the method 300 employs an asymmetric algorithm, the private key should be protected by symmetric algorithm as known in the art.

The illustrated method 300 further comprises a hashing step 306. In the illustrated method 300, the hashing 306 may comprise utilizing a known, one-way hashing algorithm, for example, one listed in Table 3, to obfuscate the location of the encrypted data, or the cryptographic algorithm used, using a well-defined key such as the key used to encrypt data in step 304. For example, after encrypting data, the method may “save” the data to a storage module using a filename corresponding to the hashed key. Thus, as can be seen both the decryption algorithm and the hashing algorithm require the use of the key data in order to access the secure data. First, the correct key must be hashed in order to access the encrypted data. Secondly, the correct key must be used to properly decrypt the encrypted data after accessed is allowed. Although illustrated as using the same key for access and decryption, alternatively embodiments may further exist where distinct keys are utilized for both steps of decryption and file access.

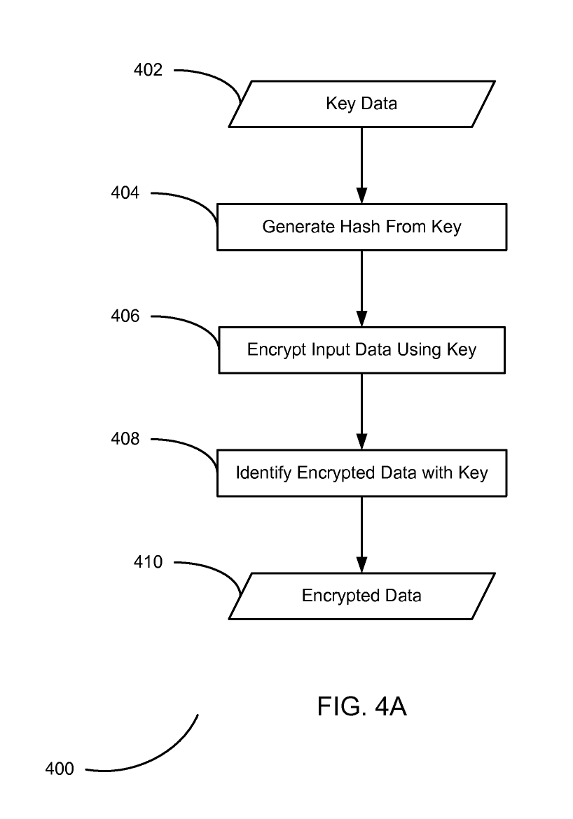

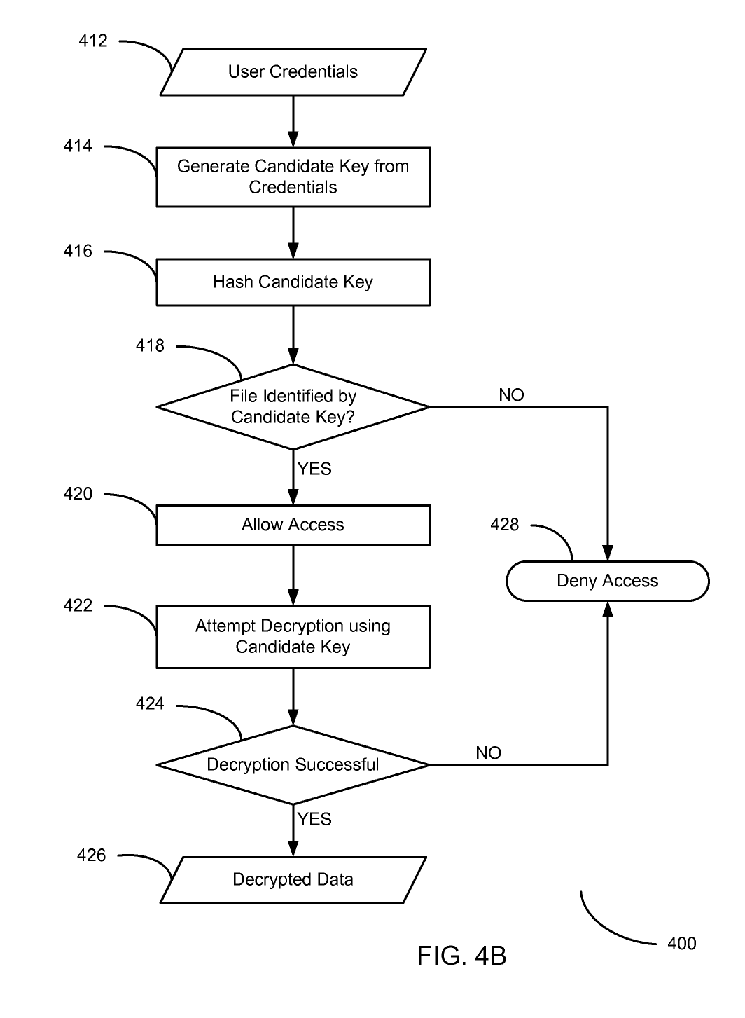

FIGS. 4A and 4B illustrate a method for encrypting and decrypting data according to one embodiment of the disclosure. As the embodiment of FIGS. 4A and 4B illustrate, a method 400 receives a key, step 402. The method 400 may receive a key in numerous ways including, but not limited to, receiving a key via a graphical user interface (“GUI”) or via a network such as through a website or other authentication means. In one embodiment, a key may be generated based on textual data, such as a username and password. For example, in a simplistic scenario a username (“Patent”) and password (“Examiner”) may be combined to form the key “PatentExaminer.” Alternatively, more sophisticated mechanisms may be utilized to formulate a key from an underlying data source.

The method 400 then generates a hash from the generated key, step 404. In the illustrated embodiment, the method 400 may generate a hash utilizing a hashing algorithm such as one listed in Table 3. By way of example, the method 400 may utilize the MD5 hashing algorithm to generate a hash for the key “PatentExaminer” consisting of the string “d1cdd045eb356a132b9f5ecd9069a5c6”. Alternatively, the method 400 may utilize a more sophisticated algorithm for generating a hash that obfuscates the type of hashing mechanism used. In one embodiment, the method 400 may choose an appropriate hash function based on the contents of the key, or underlying data source, itself. That is, the method 400 may utilize the length of the key to determine an appropriate hashing algorithm. For example, as the key “PatentExaminer” contains 14 characters, the method 400 may choose the 14th hashing algorithm present in a well-defined list. If such a list corresponded to Table 13, the method 400 may choose the “Tiger” hashing algorithm as this algorithm is the 14th algorithm in the list presented in Table 3. In addition to this selection process, the method 400 may utilize a custom scheme that modifies the resultant hash according to a well-defined algorithm, thus making the resultant hash undetectable using brute force methods such as detecting the length of a hash to determine the associated algorithm.

After generating the appropriate hash for a given key, the method 400 encrypts input data using the hashed key, step 406. As previously discussed, the method 400 may utilize either an asymmetric, symmetric, or comparable algorithm to securely encrypt the contents of the input data. As with generating the hashed key, the method 400 may utilize a more sophisticated algorithm to choose an encryption algorithm. As with the hashed key, the method 400 may utilize the length of the underlying key data source (e.g., a length of 14 for “PatentExaminer”) to determine which algorithm to use. Alternatively, or in conjunction with the foregoing, the method 400 may utilize a determination as to whether the length is even to choose between asymmetric or symmetric algorithms. Thus, for example, since “PatentExaminer” is of even length, the method 400 may decide to use an asymmetric algorithm that is the 14th algorithm in a well-defined list such as Table 2. Thus, the method 400 may choose the GMR algorithm to encrypt and decrypt the given input data.

After encrypting the data, step 406, the method 400 identifies the encrypted data using the hashed key, step 408, and stores the data, step 410. As previously discussed, the method 400 may utilize the hashed key as a “filename” or other identifier to later access. Thus, in one example, the method 400 may write the encrypted data to data storage, such as a hard disk, using the hashed key (e.g., “d1cdd045eb356a132b9f5ecd9069a5c6”) as a filename. While illustrated as a filename, the method 400 alternatively may utilize the hashed key to generate a full file path (e.g., “/mnt/storage/d1cdd/045eb356/a132b9f5e/cd906/9a5c6”). As can be seen, the method 400 may utilize the hashed key to generate a semi-unique folder structure for a given hashed key.

Subsequent to storing encrypted data, the method 400 receives a request for data including credentials associated with a user, step 412. Notably, this receipt occurs at a point subsequent in time to the storing of the encrypted data.

The method 400 first attempts to generate a key from the received credentials, step 414 and generate a hash from the candidate key, step 416. As discussed with respect to step 404, the mechanism applied may be identical to the methodology applied to secure the data. That is, for example, the user credentials (e.g., username and password) may be concatenated and passed through a selected hashing algorithm. In one embodiment, the hashing algorithm may be selected as a function of the generated key.

The method 400 then attempts to identify a file based on the candidate key, step 418. In one embodiment, the method 400 may attempt to search a file system using the candidate key as a filename and/or file path as discussed previously. Alternatively, the candidate key may utilized as an offset or index to an array of files or a database (e.g., as a “primary key”). If no file exists, the method 400 denies access to the file associated with the supplied credentials, step 428. If the method 400 is able to locate an encrypted file associated with the candidate key, the method 400 allows access, step 420, (e.g., by opening the file) and attempts to decrypt the file using the candidate key, step 422. As discussed with respect to encryption, the method 400 may utilize the candidate key as the encryption key in order to decrypt the contents of the file. In alternative embodiments, the method 400 may utilize the key to determine the appropriate decryption algorithm to utilize, as discussed previously.

If decryption is successful, step 424, the method 400 provides the decrypted data to the requesting user, step 426. If decryption fails, step 424, the method 400 denies access to the requested resource, step 428.

FIGS. 1 through 4B are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a non-transitory machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to non-transitory media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system for securing data, the system comprising:
an input/output device;
a storage device operative to store encryption key data and encrypted information;
a hashing module operative to generate a hashed key based on the key data using a hashing algorithm;
an encryption module operative to encrypt input data using an encryption algorithm and the hashed key and generate encrypted data; and
a decryption module operative to decrypt the encrypted data using a decryption algorithm and a key received from the input/output device, wherein the decryption hashes the received key and decrypts the encrypted data using the hashed, received key.

2. The system of claim 1 wherein the encryption key data is generated based on input data.

3. The system of claim 2 wherein the input data comprises a username and password.

4. The system of claim 1 wherein the hashing module selects a hashing algorithm based on the key data.

5. The system of claim 1 wherein the encryption module and decryption module choose an encryption/decryption algorithm based on the key data.

6. The system of claim 1 wherein the encryption module further stores the encrypted data within the storage device.

7. The system of claim 6 wherein the encryption module stores the encrypted data using a filename based on the hashed key data.

8. The system of claim 1 wherein the encryption algorithm comprises an asymmetric encryption algorithm.

9. The system of claim 1 wherein the encryption algorithm comprises an symmetric encryption algorithm.

10. A method for securing data, the method comprising:
receiving key data;
generating a hashed key based on the key data using a hashing algorithm;
encrypting input data using an encryption algorithm and the hashed key to generate encrypted data; and
decrypting the encrypted data using a decryption algorithm a key received from the input/output device, wherein the decrypting comprises hashing the received key and decrypting the encrypted data using the hashed, received key.

11. The method of claim 10 wherein the received key data is generated based on input data.

12. The method of claim 11 wherein the input data comprises a username and password.

13. The method of claim 10 further comprising selecting a hashing algorithm based on the key data.

14. The method of claim 10 further comprising choosing an encryption/decryption algorithm based on the key data.

15. The method of claim 10 further comprising storing the encrypted data.

16. The method of claim 15 wherein storing the encrypted data comprises storing the encrypted data using a filename based on the hashed key data.

17. The method of claim 10 wherein the encryption algorithm comprises an asymmetric encryption algorithm.

18. The method of claim 10 wherein the encryption algorithm comprises an symmetric encryption algorithm.

19. Non-transitory computer readable media comprising program code that when executed by a programmable processor causes execution of a method for securing data, the computer readable media comprising:
computer program code for receiving key data, wherein the received key data is generated based on input data;
computer program code for generating a hashed key based on the key data using a hashing algorithm;
computer program code for encrypting input data using an encryption algorithm and the hashed key to generate encrypted data;
computer program code for storing the encrypted data, wherein storing the encrypted data comprises storing the encrypted data using a filename based on the hashed key data; and
computer program code for decrypting the encrypted data using a decryption algorithm a key received from the input/output device, wherein the decrypting comprises hashing the received key and decrypting the encrypted data using the hashed, received key.

20. The computer readable medium of claim 19 further comprising computer program code for: selecting a hashing algorithm based on the key data and choosing an encryption/decryption algorithm based on the key data
